(19) United States
(12) Patent Application Publication
(10) Pub. No.: US 2003/0017745 A1
(43) Pub. Date: Jan. 23, 2003

(54) Cable reel

(75) Inventor: Akihito Maegawa, Yokkaichi-city (JP)

Correspondence Address: GREENBLUM & BERNSTEIN, P.L.C., 1941 ROLAND CLARKE PLACE, RESTON, VA, 20191, US

(73) Assignee: Sumitomo Wiring Systems, Ltd., Yokkaichi-city (JP)

(21) Appl. No.: 10/187,992

(22) Filed: Jul. 3, 2002

(30) Foreign Application Priority Data
Jul. 17, 2001 (JP) 2001-217302

(51) Int. Cl. H01R 13/68

(52) U.S. Cl. 439/621

(57) ABSTRACT

A cylindrical stationary member and a cylindrical movable member are coaxially and rotatably coupled to each other in a cable reel. A flat cable is accommodated in an annular space defined between the stationary member and the movable member. Conductive elements juxtaposed in the flat cable are connected to bus bars fixed in the stationary and movable members at the longitudinal opposite ends of the flat cable. The bus bars are connected to electric wires of external circuits. A fuse is interposed in the bus bars connected to at least one of the opposite ends of the flat cable.

### BACKGROUND OF THE INVENTION

1. Field of the Invention

This invention relates to a cable reel to be mounted on a steering device of a vehicle such as, for example, an automobile.

2. Description of the Related Art

For convenience of explanation, a conventional cable reel will be described with reference to FIGS. 5 and 6. FIG. 5 is an exploded perspective view of a cable reel. FIG. 6 is a perspective view of a conventional inner case, illustrating an interior of the inner case.

A conventional cable reel 1 to be mounted on a steering device of an automobile, as shown in FIG. 5, has a stationary member 4 configured to be secured to a steering column and a movable member 2 configured to be secured to a steering wheel. Both members 4 and 2 are rotatably coupled to each other. A flat cable 3 is contained in an annular space defined between the stationary member 4 and the movable member 2 in a convoluted manner.

Opposite ends of the flat cable 3, as shown in FIG. 6, are connected to ends 6a of bus bars 6 fixed in inner cases 5 secured to the stationary member 4 and movable member 2, respectively. The other ends 6b of the bus bars 6 are connected to core elements 7a in lead wires 7 of an external circuit.

However, since the above noted conventional cable reel 1 does not protect the flat cable 3 when a short-circuit occurs between circuits, the flat cable 3 will tend to melt and generate fumes.

Also, when an overcurrent occurs in an air bag circuit, an air bag will malfunction.

### SUMMARY OF THE INVENTION

In order to address the problems described above, an object of the present invention is to provide a cable reel that protects for an overcurrent in circuits in order to prevent a flat cable from fuming and devices from malfunctioning.

An aspect of the present invention is directed to a cable reel wherein a cylindrical movable member is rotatably and coaxially coupled to a cylindrical stationary member, a flat cable is accommodated in an annular space defined between the stationary and movable members, conductive elements juxtaposed in the flat cable are connected to bus bars fixed in the stationary and movable members at the longitudinal opposite ends of the flat cable, and the bus bars are connected to electric wires of external circuits. The cable reel includes a fuse interposed in at least one of the bus bar connected to at least one of the opposite ends of the flat cable.

Another aspect of the present invention is directed to a cable reel which includes a cylindrical movable member and a cylindrical stationary member. The cylindrical movable member is rotatably and coaxially coupled to the cylindrical stationary member. The cable reel also includes a flat cable accommodated in an annular space defined between the stationary and movable members. The flat cable includes conductive elements juxtaposed therein. The cable reel also includes bus bars respectively fixed in the stationary and movable members. The bus bars are connected to the conductive elements of the flat cable, at longitudinal opposite ends of the flat cable, and to electric wires of external circuits. At least one of the bus bars includes a fuse.

According to the above construction, since the fuse is interposed in the bus bar, an overcurrent will melt down the fuse, thereby protecting the circuit and avoiding danger of fumes from the flat cable.

The fuse may be provided on the bus bar connected to either end of the flat cable.

The bus bar may be divided into two separate portions, with each of the two separate portions including a tab having a press-fitting slot. The tabs of the two separate portions are arranged opposed to each other such that input and output terminals of the fuse are located in the press-fitting slots to connect the two separate portions.

The bus bar may be divided into two separate portions, with each of the two separate portions including a tab. The tabs of the two separate portions are arranged opposed to each other such that input and output terminals of the fuse are welded to the tabs to connect the two separate portions.

According the structure in which the respective terminals of the fuse are press-fitted in the press-fitting slots in the respective tabs provided on the respective ends of the two portions of the bus bar, it would be easy to attach and detach the fuse to and from the bus bar for maintenance and possible exchange of the fuse for another fuse having a different capacity, thereby allowing for common use of the bus bar.

The fuse may include a narrow width portion of the bus bar. A stamping step for forming the bus bars may form the narrow width portion of the bus bar simultaneously. This requires no separate fuse element and eliminates a step of attaching the fuse to the bus bars, thereby reducing parts count and man-hours.

The bus bar which includes the fuse may be connected to an air bag circuit. Thus, the fuses need not connected to the bus bars for all circuits and the narrow width fusing portions need not be formed in the bus bars for all circuits. It will be possible to achieve an effective countermeasure for an overcurrent by protecting an important circuit, such as an air bag circuit or the like, that is required for preventing a malfunction due to an overcurrent. However, the bus bars for all circuits may have fuses and/or narrow width fusing portions. In other words, the fuses or narrow width fusing portions may be selectively provided, if desired.

### BRIEF DESCRIPTION OF THE DRAWINGS

The above and other objects, features and advantages of the present invention will be made apparent from the following description of the preferred embodiments, given as non-limiting examples, with reference to the accompanying drawings in which:

FIG. 1 is a perspective view of an inner case of a first embodiment in accordance with the present invention;

FIG. 2 is a perspective view of bus bars in the inner case of the first embodiment;

FIG. 3 is a perspective view of bus bars in the inner case of a second embodiment;

FIG. 4A is a perspective view of bus bars in the inner case of a third embodiment;

FIG. 4B is a perspective view of a bus bar having a fusing portion of the third embodiment;

FIG. 5 is an exploded perspective view of a conventional cable reel; and

FIG. 6 is a perspective view of a conventional inner case, illustrating an interior of the inner case.

### DEATAILED DESCRIPTION OF THE PREFERRED EMBODIMENTS

Referring now to the drawings, embodiments of a cable reel in accordance with the present invention will be explained below.

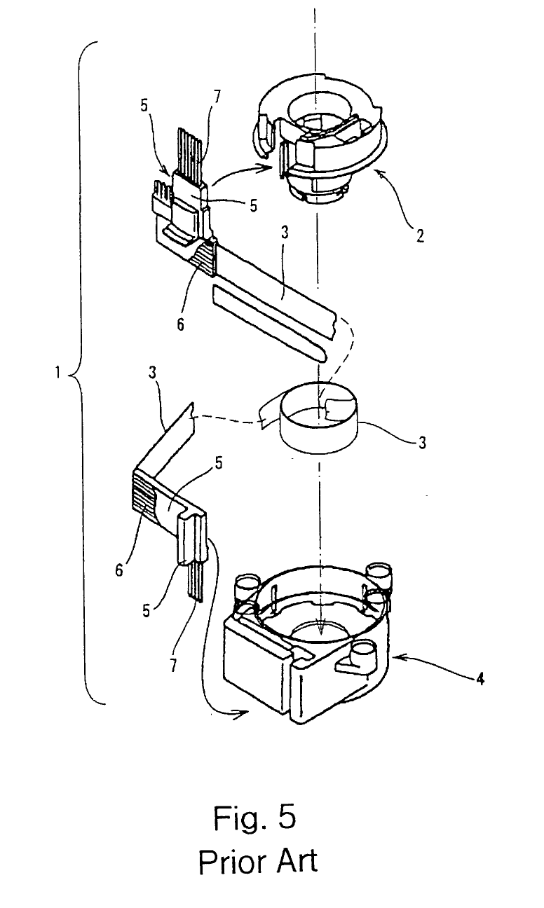

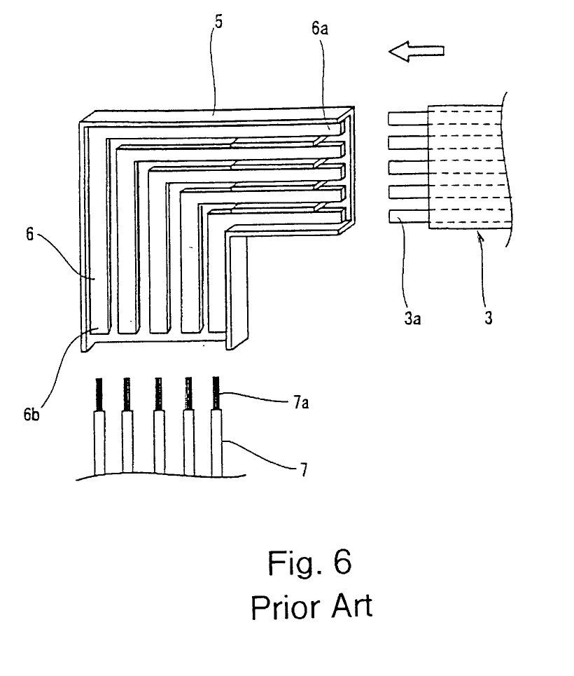

Inner cases connected to the opposite ends of a flat cable in the present embodiments can be applied to the conventional cable reel shown in FIG. 5. Since a general structure of a cable reel in the present invention is the same as that of the conventional cable reel shown in FIG. 5, an explanation of the general structure is omitted here.

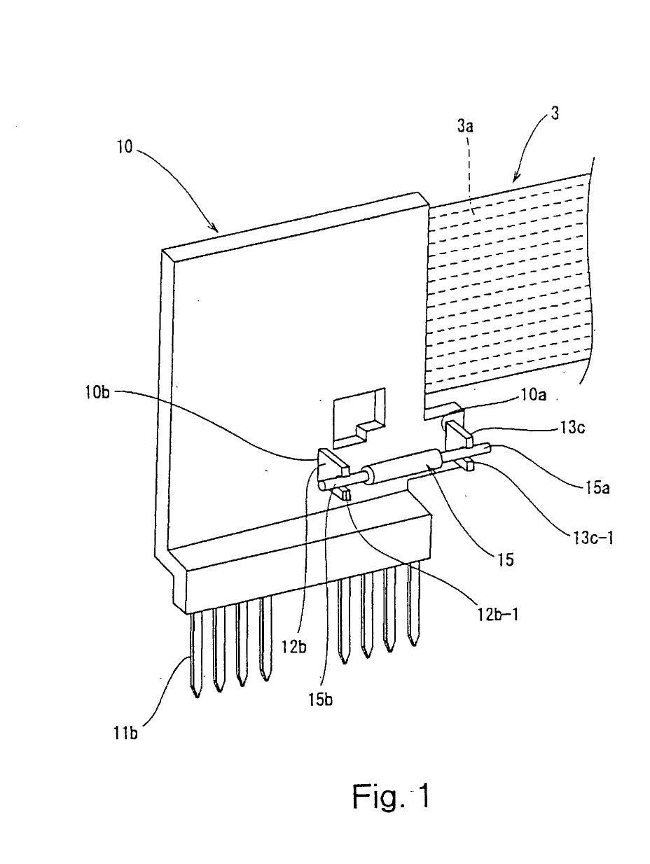

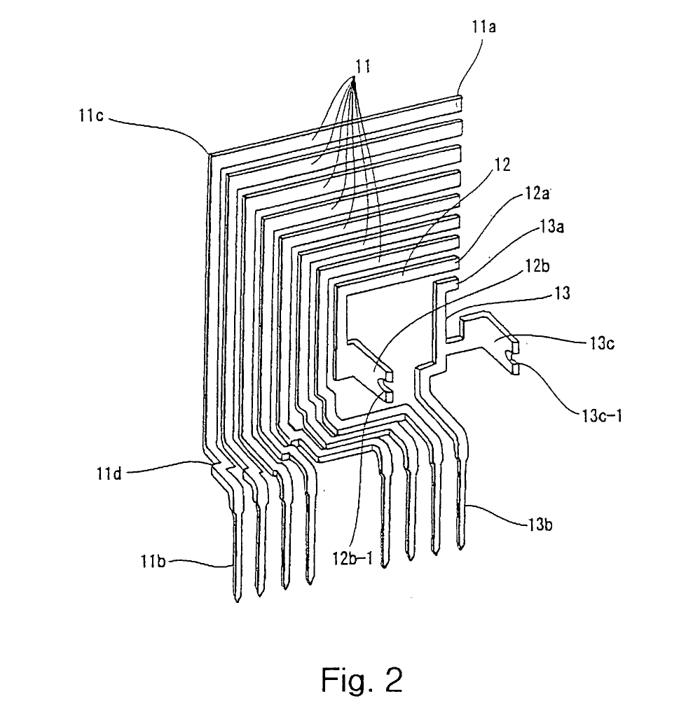

FIGS. 1 and 2 show a first embodiment of a cable reel in accordance with the present invention.

FIG. 1 illustrates an inner case 10 attached to an end of a flat cable 3. Bus bars 11 are secured in the interior of the inner case 10. Terminal portions 11b of the bus bars 11 protrude from a lower end of the inner case 10 in a juxtaposed manner to connect external circuits to the bus bars.

FIG. 2 illustrates bus bars 11 secured to the interior of the inner case 10.

Each of seven bus bars 11 disposed at the outside in FIG. 2 includes a horizontal connection end 11a to be connected to a conductive element in the flat cable 3, a bent portion 11c that bends a horizontal portion of the bus bar down vertically at a right angle, a pitch adjustment portion 11d that bends a vertical portion of the bus bar forward, and a terminal portion 11b that extends down from the pitch adjustment portion 11d in a manner juxtaposed at a given pitch with respect to the other bus bars.

A bus bar 12 disposed inside the seven bus bars 11 in FIG. 2 includes a horizontal connection end 12a to be connected to a conductive element in the flat cable 3, a bent portion that bends a horizontal portion of the bus bar down vertically at a right angle, and a tab 12b that extends forward from a vertical portion of the bus bar and has a press-fitting slot 12b-1.

A bus bar 13 disposed further inside the bus bar 12 in FIG. 2 includes a horizontal connection end 13a to be connected to a conductive element in the flat cable 3, bent portion that bends a horizontal portion of the bus bar down vertically at a right angle, a tab 13c that extends forward from a vertical portion of the bus bar and has a press-fitting slot 13c-1, and a terminal portion 13b that extends down in a manner juxtaposed at a given pitch with respect to the other bus bars 11b.

The tabs 12b and 13c, as shown in FIG. 1, are exposed outward through openings 10a and 10b in a front surface of the inner case 10. An input terminal 15a and an output terminal 15b of a fuse 15 are press-fitted in the press-fitting slots 12b-1 and 13c-1.

According to the above construction, since the fuse 15 is interposed in a circuit, such as an air bag circuit, to be connected to the bus bars 12 and 13, even if an overcurrent flows in the circuit, the fuse 15 will melt down and the flat cable 3 will not be melted, thereby avoiding a danger of fumes or the like from the flat cable 3.

Since the fuse 15 and bus bars 12 and 13 are interconnected in a press-fitting manner, it is possible to easily attach and detach the fuse 15 to and from the bus bars 12 and 13 for maintenance and to exchange the fuse for another fuse having a different capacity, thereby allowing for common use of bus bars.

The inner case having the fuse may be attached to either a movable member to be connected to an end of the flat cable or a stationary member to be connected to the other end of the flat cable.

Although the fuse may be provided selectively on an important circuit, such as an air bag circuit, that is necessary to prevent a malfunction due to an overcurrent, all of the desired circuits may be provided with the fuses.

In addition, in order to prevent a malfunction of input and output, other elements, such as resistors or capacitors, may be attached to the bus bar in the same manner as the fuse.

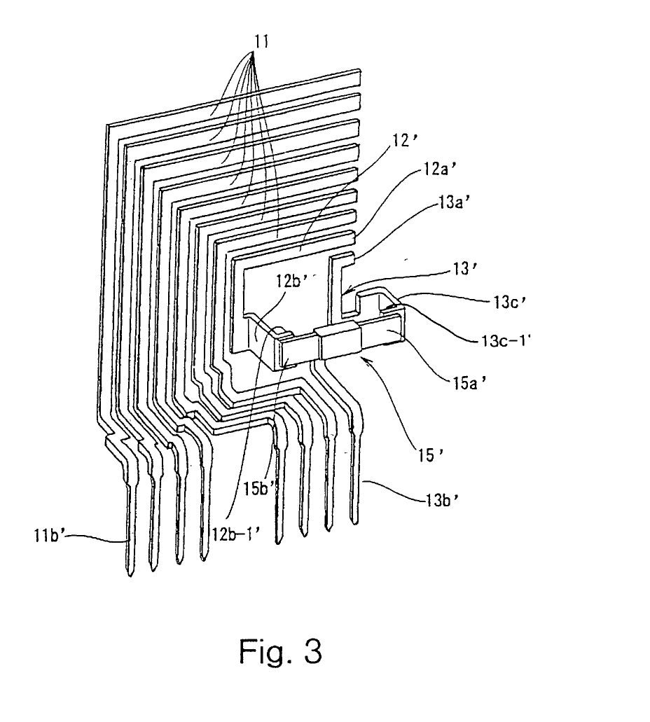

FIG. 3 shows a second embodiment of the cable reel in accordance with the present invention.

The second embodiment differs from the first embodiment with respect to the fact that a fuse 15′ is connected to bus bars 12′ and 13′ by welding rather than press-fitting.

FIG. 3 shows the bus bars 11, 12′ and 13′ fixed on the interior of the inner case to be connected to an end of the flat cable. The bus bars 11 are the same as those in the first embodiment.

The bus bar 12′ disposed inside the seven bus bars 11 in FIG. 3 includes a horizontal connection end 12a′ to be connected to a conductive element in the flat cable 3, a bent portion that bends a horizontal portion of the bus bar down vertically at a right angle, a tab 12b′ that extends forward from a vertical portion of the bus bar and a distal end 12b-1′ bent horizontally from the tab 12b′ at a right angle (toward the right side in FIG. 3).

The bus bar 13′ disposed further inside the bus bar 12′ in FIG. 3 includes a horizontal connection end 13a′ to be connected to a conductive element in the flat cable 3, a bent portion that bends a horizontal portion of the bus bar down vertically at a right angle, a tab 13c′ that extends forward from a vertical intermediate portion of the bus bar and a distal end 13c-1′ bent horizontally from the tab 13c′ at a right angle (toward the left side in FIG. 3). Also, a terminal portion 13b′ extends down from the bus bar 13′ in a manner juxtaposed at a given pitch with respect to the other bus bars 11b′.

An input terminal 15a′ and an output terminal 15b′ of a rectangular fuse 15′ are attached to the distal ends 12b-1′ and 13c-1′ of the tabs 12b′ and 13c′ by any suitable attachment process, such as ultrasonic welding or resistance welding.

According to the above construction, since the fuse 15′ is interposed in a circuit to be connected to the bus bars 12′ and 13′, even if an overcurrent flows in the circuit, the fuse 15′ will melt down and the flat cable 3 will not be melted, thereby avoiding a danger of fumes or the like from the flat cable 3.

Since the fuse 15′ is connected to the bus bars 12′ and 13′ by welding, it is possible to prevent the fuse 15′ from falling out of the bus bars, thereby enhancing reliability of connection.

The fuse 15′ may be connected to the bus bars 12′ and 13′ any other suitable manner, such as by soldering.

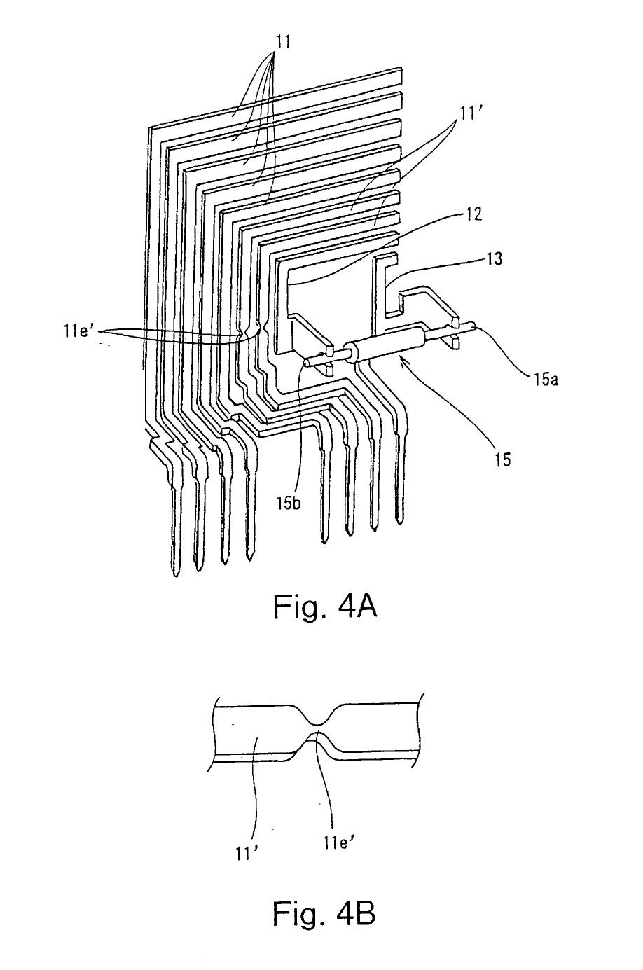

FIGS. 4A and 4B show a third embodiment of the cable reel in accordance with the present invention. The third embodiment differs from the first embodiment with respect to the fact that fusing portions 11e′ having a narrow width are formed in several bus bars 11′.

FIG. 4A illustrates the bus bars 11′, 12 and 13 fixed on the interior of the inner case to be connected to an end of the flat cable. The five bus bars 111 disposed outside two bus bars 11′ in FIG. 4A are the same as those in the first embodiment. The two inside bus bars 11′ have fusing portions 11e′ on the intermediate portions.

The fusing portion 11e′, as shown in FIG. 4B, is formed into a narrow width portion simultaneously when the bus bars 11′ are formed by stamping.

A bus bar 12 disposed inside the bus bars 11′ and a bus bar 13 disposed inside the bus bar 12 are the same as those in the first embodiment. The input terminal 15a and an output terminal 15b of a fuse 15 are press-fitted in the press-fitting slots 12b-1 and 13c-1 in the tabs 12b and 13c.

According to the above construction, the other circuits to be connected to the other bus bars 11′ can be protected by the fusing portion 11e′ while a circuit, such as an air bag circuit, to be connected to the bus bars 12 and 13 can be protected by the fuse 15.

Since the fusing portion 11e′ having a narrow width is formed simultaneously by a stamping process of the bus bars 11′, it is not necessary to form a tab and to provide an additional fuse, thereby reducing parts count and man-hours.

Although the fusing portion 11e′ and fuse 15 are provided on only important circuits, they may be provided on all of the circuits.

From the above description of the invention, those skilled in the art will perceive improvements, changes and modifications. Such improvements, changes and modifications within the skill of the art are intended to be covered by the appended claims. Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese application No. 2001-217302 filed on Jul. 17, 2001, the disclosure of which is herein expressely incorporated by reference it its entirety.

What is claimed is:

1. In a cable reel in which a cylindrical movable member is rotatably and coaxially coupled to a cylindrical stationary member, a flat cable is accommodated in an annular space defined between the stationary and movable members, conductive elements juxtaposed in the flat cable are connected to bus bars fixed in the stationary and movable members at longitudinal opposite ends of the flat cable, and the bus bars are connected to electric wires of external circuits, said cable reel comprising at least one fuse interposed in at least one of the bus bars connected to at least one of the opposite ends of the flat cable.

2. The cable reel according to claim 1, wherein said at least one bus bar is formed in two separate portions, each of the two separate portions including a tab having a press-fitting slot, the tabs of the two separate portions being arranged opposed to each other such that input and output terminals of said at least one fuse are located in the press-fitting slots to connect the two separate portions.

3. The cable reel according to claim 1, wherein said at least one bus bar is formed in two separate portions, each of the two separate portions including a tab, the tabs of the two separate portions being arranged opposed to each other such that input and output terminals of said at least one fuse are welded to the tabs to connect the two separate portions.

4. The cable reel according to claim 1, wherein said at least one fuse comprises a narrow width portion of said at least one bus bar.

5. The cable reel according to claim 1, wherein said at least one bus bar is connected to an air bag circuit.

6. The cable reel according to claim 2, wherein said at least one bus bar is connected to an air bag circuit.

7. The cable reel according to claim 3, wherein said at least one bus bar is connected to an air bag circuit.

8. The cable reel according to claim 4, wherein said at least one bus bar is connected to an air bag circuit.

9. A cable reel comprising:
a cylindrical movable member and a cylindrical stationary member, wherein said cylindrical movable member is rotatably and coaxially coupled to said cylindrical stationary member;
a flat cable accommodated in an annular space defined between said stationary and movable members, said flat cable including conductive elements juxtaposed therein; and
bus bars respectively fixed in said stationary and movable members, wherein said bus bars are connected to the conductive elements of said flat cable, at longitudinal opposite ends of said flat cable, and to electric wires of external circuits;
wherein at least one of said bus bars includes a fuse.

10. The cable reel according to claim 9, wherein said at least one bus bar is formed in two separate portions, each of the two separate portions including a tab having a press-fitting slot, the tabs of the two separate portions being arranged opposed to each other such that input and output terminals of said fuse are located in the press-fitting slots to connect the two separate portions.

11. The cable reel according to claim 9, wherein said at least one bus bar is formed in two separate portions, each of the two separate portions including a tab, the tabs of the two separate portions being arranged opposed to each other such that input and output terminals of said fuse are welded to the tabs to connect the two separate portions.

12. The cable reel according to claim 9, wherein said fuse comprises a narrow width portion of said at least one bus bar.

13. The cable reel according to claim 9, wherein said at least one bus bar is connected to an air bag circuit.

14. The cable reel according to claim 10, wherein said at least one bus bar is connected to an air bag circuit.

15. The cable reel according to claim 11, wherein said at least one bus bar is connected to an air bag circuit.

16. The cable reel according to claim 12, wherein said at least one bus bar is connected to an air bag circuit.
